(19) United States
(12) Patent Application Publication
(10) Pub. No.: US 2023/0030578 A1
(43) Pub. Date: Feb. 2, 2023

(54) HYBRID POWDER FEED DEVICE

(71) Applicant: 6K Inc., North Andover, MA (US)

(72) Inventors: Jared Majcher, Portsmouth, NH (US); Michael Kozlowski, Reading, MA (US); Makhlouf Redjdal, Stoneham, MA (US)

(73) Assignee: 6K Inc., North Andover, MA (US)

(21) Appl. No.: 17/873,776

(22) Filed: Jul. 26, 2022

Related U.S. Application Data
(60) Provisional application No. 63/226,299, filed on Jul. 28, 2021.

(51) Int. Cl. B05B 7/14; B65G 53/08

(52) U.S. Cl. CPC B05B 7/1431; B65G 53/08; C23C 4/134

(57) ABSTRACT

A system for processing fine powders includes a hopper for dispensing powder material through a hopper outlet, and a feeding chamber positioned downstream of the hopper outlet to receive the powder material and convey the powder material to a plasma torch. The system also includes an auger positioned at the hopper outlet, a mechanical vibrator and a mesh screen attached to a flange of the feeding chamber, and a pneumatic system providing a gas flow sufficient to propel the powder material without extinguishing a plasma of the plasma torch.

### CROSS REFERENCE TO RELATED APPLICATIONS

This application claims the benefit of and priority to U.S. Application Number 63/226,299, filed on Jul. 28, 2021, and entitled "Hybrid Powder Feed Device", the contents of are hereby incorporated in their entirety.

### FIELD OF THE INVENTION

The present technology generally relates to devices, systems, and methods for feeding material into a plasma for processing of the material by the plasma. In particular, the present technology relates to a system for conveying powder material from a hopper to a plasma torch using any combination of a pneumatic system, an auger, and a vibrating mesh screen.

### BACKGROUND

Plasma torches provide a high temperature plasma for a variety of purposes. In general, there are several types of plasma torches including induction plasma torches and microwave plasma torches. Other types of plasma torches can include direct current (DC) plasma, with arcing between a cathode and anode. These types of plasma torches provide substantially different high temperatures, with microwave plasma reaching about 6,000 K and the rest reaching about 10,000 K.

These high temperature plasmas may enable processing of a variety of materials that are exposed to or fed into the plasma. One such type of processing is taking one or more materials of a particular size and shape and, by exposing or feeding it into the plasma, changing the one or more materials into a different size and/or shape.

### SUMMARY

Provided herein are devices and methods for providing material feedstock into a plasma of a plasma torch. According to one aspect, the present disclosure relates to a system for processing fine powders. The system includes a hopper for dispensing powder material through a hopper outlet, and a feeding chamber positioned downstream of the hopper outlet to receive the powder material and convey the powder material to a plasma torch. The system also includes a pneumatic system providing a gas flow sufficient to propel the powder material without extinguishing a plasma of the plasma torch, an auger positioned at the hopper outlet, and a mechanical vibrator and a mesh screen attached to a flange of the feeding chamber. In some embodiments, the mechanical vibrator vibrates the mesh screen at a frequency between 1000 and 10000 Hz. In some embodiments, the pneumatic system provides a gas flow between 10 and 60.

According to another aspect, the present disclosure relates to a method of feeding fine powders into a plasma torch. The method includes operating a hopper to dispense powder material through a hopper outlet, and rotating an auger positioned at the hopper outlet to deliver the powder material from the hopper outlet to a feeding chamber. The method also includes vibrating a mechanical vibrator connected to a mesh screen at an outlet of the feeding chamber to deliver a metered volume of powder material through the outlet of the feeding chamber. The method also includes conveying a gas flow through a pneumatic system connected to the outlet of the feeding chamber to convey the powder material from the outlet of the feeding chamber to a plasma torch. In some emboidments, the rotation speed of the auger, frequency of vibration of the mechanical vibrator, and gas flow speed are each selected to produce a desired flow of powder material into the plasma torch. In some embodiments, vibrating the mechanical vibrator includes vibrating the mesh screen at a frequency between 1000 to 10000 Hz. In some embodiments, operating the hopper includes dispensing powder material having a size distribution between 10 to 100 microns.

According to another aspect, the present disclosure relates to a system for processing fine powders that includes a hopper for dispensing powder material through a hopper outlet, a feeding chamber, and a hybrid powder feed system. The feeding chamber is positioned downstream of the hopper outlet to receive he powder material and convey the powder material to a plasma torch. The hybrid powder feed system includes at least two of: a pneumatic system, an auger positioned at the hopper outlet, or a vibrating mesh screen device positioned at an outlet of the feeding chamber. In some embodiments, the hybrid powder feed system includes the pneumatic system and the vibrating mesh screen device positioned at the outlet of the feeding chamber. In some embodiments, the hybrid powder feed system includes the pneumatic system and the auger positioned at the hopper outlet. In some embodiments, the hybrid powder feed system includes the vibrating mesh screen device positioned at the outlet of the feeding chamber and the auger positioned at the hopper outlet. In some embodiments, the hybrid powder feed system includes the pneumatic system, the auger positioned at the hopper outlet, and the vibrating mesh screen device positioned at the outlet of the feeding chamber. In some embodiments, the vibrating mesh screen device includes a mechanical vibrator and a mesh screen attached to a flange of the feeding chamber. In some embodiments, the mesh screen has between 100 to 225 openings per inch. In some embodiments, the mechanical vibrator vibrates the mesh screen at a frequency between 1000 and 10000 Hz. In some embodiments, the hopper is designed to dispense powder material having a size distribution between 10 to 100 microns. In some embodiments, the auger includes variable pitch or variable diameter along its length. In some embodiments, the pneumatic system provides a gas flow between 10 to 60 SCFH argon. In some embodiments, the gas flow is sufficient to propel the powder material without extinguishing a plasma of the plasma torch. In some embodiments, the pneumatic system includes a tee junction and parallel gas line for providing a secondary gas flow to the hopper.

### BRIEF DESCRIPTION OF THE DRAWINGS

The invention may be more fully understood from the following detailed description taken in conjunction with the accompanying drawings.

FIG. 1 shows an example system for dispensing fine powders including an auger and vibrating mesh screen, according to one embodiment of the present disclosure.

FIG. 2 shows an example mechanical vibrator attached to a flange of a feeding chamber, according to one embodiment of the present disclosure.

FIG. 3 shows an example mesh screen that can be attached to a flange of a feeding chamber, according to one embodiment of the present disclosure.

FIG. 4 shows another example system for dispensing fine powders including an auger, a feeding chamber with a mesh screen, and a pneumatic system, according to one embodiment of the present disclosure.

FIG. 5 shows an example pneumatic system connected to a funnel of a feeding chamber, according to one embodiment of the present disclosure.

FIG. 6 shows an example powder feed system for conveying powder material to a plasma torch, according to one embodiment of the present disclosure.

FIG. 7 is a flow chart illustrating a method of dispensing powder material using a hybrid powder feed device, according to one embodiment of the present disclosure.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present technology.

In general, aspects of the present technology are directed to devices, systems and methods relating to material feeding devices for plasma processing. In some embodiments, various materials can be processed using a plasma torch, including very fine powders between about 10 to 100 microns. However, a significant challenge arises with very fine powders, as they may not flow well. Decreased particle flow can clog the processing system and decrease yeild. This can pose a particular problem when the very fine particles are not spherical. In some embodiments, the powder particles could be of various morphologies such as angular powder, angular chips, irregular powder, sponge powders, etc.

If the particles clump together, they may become too large to be properly processed by the plasma. Material processing is adversely affected when the powder material concentration (in g/cm³) (i.e. the number of the particles within the plasma) is too high. In this condition, the high concentration of the material lessens the available energy and saturates the process. One way to improve processing is to prevent the particles from clumping together. The hybrid powder feed schemes disclosed herein are techniques that can help resolve this issue.

The embodiments disclosed herein can increase particle flow for very fine powders, and prevent the fine powders from clumping or joining together, using a hybrid powder feed design. The hybrid powder feed design includes one or more of the following systems for conveying powder material from a hopper to a plasma torch: a pneumatic system, an auger or screw feeder, and a vibrating mesh screen.

The hybrid powder feeder disclosed herein solves a long felt and unsolved need for a pneumatic system for conveying fine powders to a plasma torch, combined with additional powder conveyance techniques. Typical pneumatic systems create too strong of a gas flow, which would extinguish the plasma within the plasma torch. In order to convey such fine powders at a consistent powder flow and without the particles clumping together, a combination of one or more of a pneumatic system, an auger, and a vibrating mesh screen can be used.

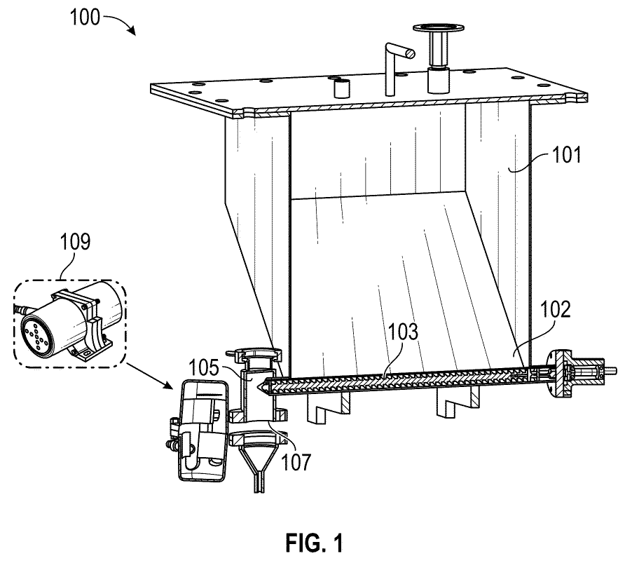

FIG. 1 shows an example system 100 for dispensing fine powders including an auger 103 and vibrating mesh screen 107, according to one embodiment of the present disclosure. In this embodiment, the system 100 includes a hopper 101 for dispensing fine powder materials. In some embodiments, the powder materials can include particles having a size distribution between about 10 to 100 microns. As discussed above, the particles could be of various morphologies such as angular powder, angular chips, irregular powder, sponge powders, etc.

The auger 103 can be positioned at the hopper outlet 102, and can rotate in order to convey the powder material to a feeding chamber 105 that is positioned downstream of the hopper outlet. The auger can include a number of blades and can have variable pitch or variable diameter along its length.

The feeding chamber 105 can include one or more flanges, which can include a flange, where a mesh screen 107 and a mechanical vibrator 109 can be secured. For example, the mesh screen 107 can be positioned within the feeding chamber 105 at the flange at a downstream end of the chamber, and a mechanical vibrator 109 can also be positioned or secured to the flange (or another component close to the mesh screen 107 in order to transfer mechanical vibrations to the screen and feeding chamber). In this way, the powder material that is deposited into the feeding chamber 105 from the auger 103 can be vibrated and dispensed through the mesh screen 107. In some embodiments, the mesh screen has a screen size between about 100 to about 225 mesh (about 100 to 225 openings per inch). In another embodiment, the mechanical vibrator vibrates the mesh screen at a particular frequency, such as between about 1000 and 10000 Hz.

In some embodiments, the dimensions and rotational speed of the auger 103, as well as the screen size of the mesh screen 107 and/or the vibration frequency of the mechanical vibrator 109 can be customized in order to achieve a desired powder flow rate out of the feeding chamber 105. These metrics can be based on the size of the powder material being dispensed, and can be customized together or individually.

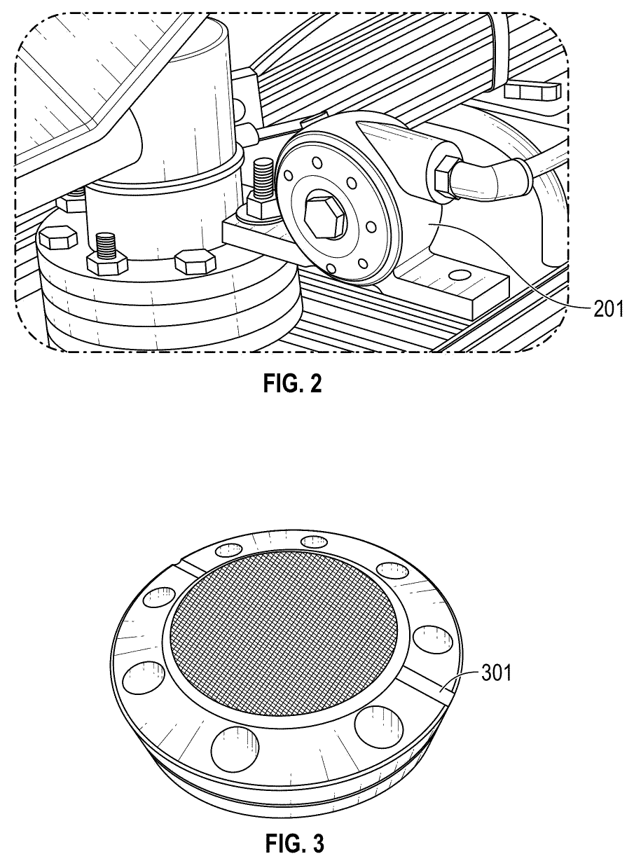

FIG. 2 shows an example mechanical vibrator 201 attached to a flange of a feeding chamber, according to one embodiment of the present disclosure. FIG. 2 illustrates an alternative design for the mechanical vibrator, as compared to FIG. 1. In this embodiment, the mechanical vibrator 201 can be secured to a flange of the feeding chamber using a bolt and screw. In this way, mechanical vibrations can be transferred from the mechanical vibrator 201 to the feeding chamber, and in turn the mesh screen that can also be sucured at the flange of the feeding chamber. In some embodiments, the vibration frequency of the mechanical vibrator 201 can be adjusted depending on the powder material size, the desired powder material flow rate, the auger speed, the screen size of the mesh screen, and/or the gas flow speed of a pneumatic system.

FIG. 3 shows an example mesh screen 301 that can be attached to a flange of a feeding chamber, according to one embodiment of the present disclosure. In this embodiment, the mesh screen 301 includes a number of drill holes that can be used to secure the mesh screen to a flange of the feeding chamber. In some embodiments, the screen size of the mesh screen 301 can be chosen or selected depending on the powder material size, the desired powder material flow rate, the auger speed, the vibration frequency of the mechanical vibrator, and/or the gas flow speed of a pneumatic system.

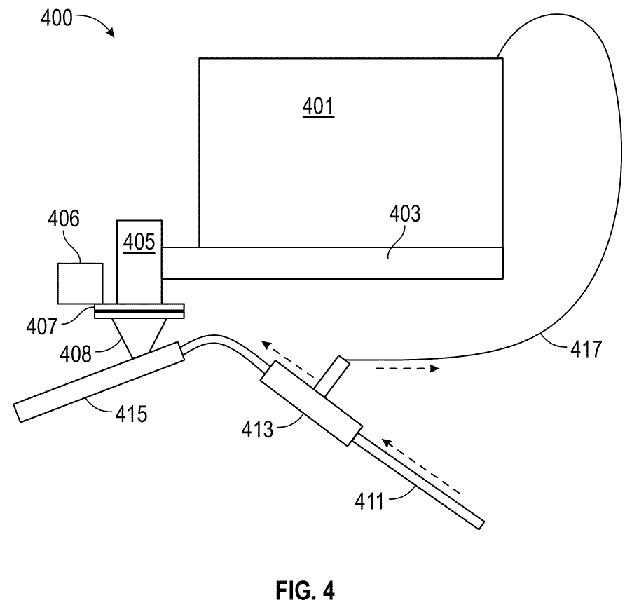

FIG. 4 is a block diagram showing another example system 400 for dispensing fine powders including an auger 403, a feeding chamber 405 with a mesh screen 407, a mechanical vibrator 406, and a pneumatic system, according to one embodiment of the present disclosure. In this embodiment, the auger 403 is positioned at an outlet of a hopper 401, and can convey powder materials to the feeding chamber 405. The mesh screen 407 and mechanical vibrator 406 are secured to the feeding chamber 405 above a funnel 408 or conical section at the output of the feeding chamber 405. In one embodiment, the hopper 401, auger 403, and mechanical vibrator 406 can each act together to dispense powder materials out of the funnel 408 of the feeding chamber 405 and to a primary gas line 415 of a pneumatic system. The pneumatic system can include an inlet gas line 411, a tee junction 413, a primary gas line 415 to a plasma torch, and a parallel gas line 417 to the hopper 401. In FIG. 4, the gas flow directions are shown in broken lines.

In some embodiments, the pneumatic system provides a gas flow through theprimary gas line 415 sufficient to propel the powder material to the plasma torch without extinguishing the plasma. An example gas flow speed can range between about 10 and 60 SCFH argon.

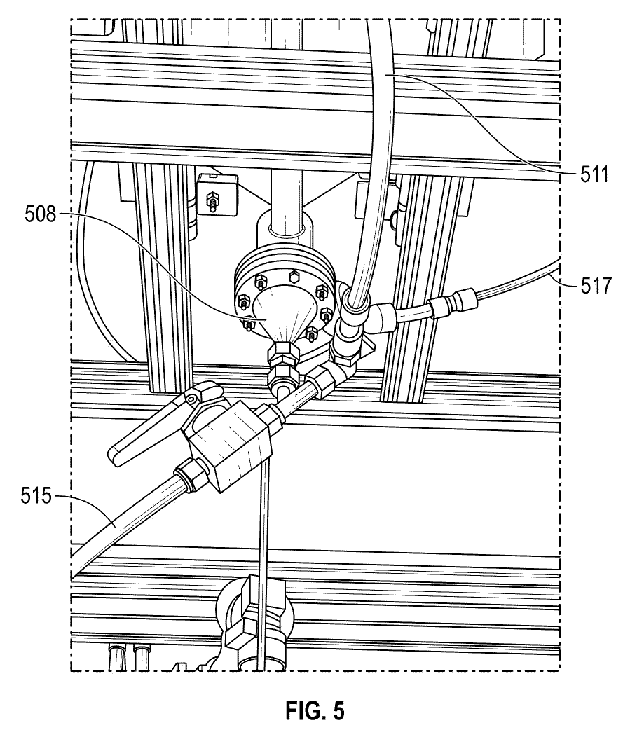

FIG. 5 shows an example pneumatic system connected to a funnel 508 of a feeding chamber, according to one embodiment of the present disclosure. As seen in FIG. 5, the pneumatic system includes an inlet gas line 511, a primary gas line 515 to direct powder material to a plasma torch, and a parallel gas line 517 to the hopper. The gas flow speed through the pneumatic system can be selected or adjusted, in some embodiments, based on the powder material size, the desired powder material flow rate, the auger speed, the vibration frequency of the mechanical vibrator, and/or the screen size of the mesh screen.

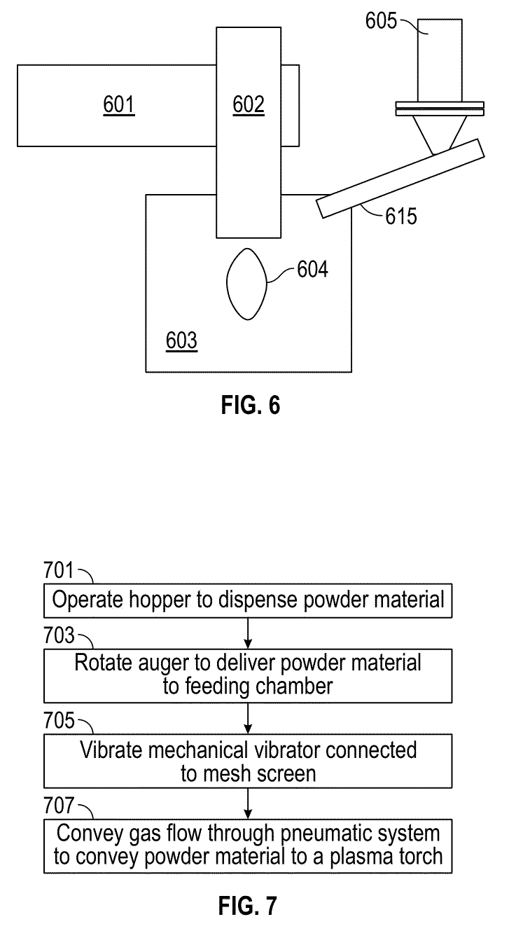

FIG. 6 shows an example powder feed system for conveying powder material to a plasma torch, according to one embodiment of the present disclosure. In this embodiment, the system includes a feeding chamber 605 that can receive powder material from a hopper and auger, as discussed above. The feeding chamber can provide powder material to a plasma torch 602, using for example a vibrator and mesh screen (not shown) and a pneumatic feed line 615. In this embodiment, a microwave plasma torch 602 is utilized, and microwave radiation can be brought into the plasma torch 602 through a waveguide 601. The feed material can be fed into the plasma chamber 603 and placed into contact with the microwave generated plasma 604. In some embodiments, the microwave generated plasma may be generated using a microwave plasma torch, as described in U.S. Pat. No. 10,477,665, and/or U.S. Pat. No. 8,748,785, each of which is hereby incorporated by reference in its entirety.

In some embodiments, the pneumatic feed line 615, or some other type of powder feeding device, can be mounted to the plasma chamber 603, or to a plasma torch housing. As discussed above, the gas flow speed of the pneumatic system can be sufficient to convey the fine powder material to the plasma torch 603 without extinguishing the plasma plume 604.

FIG. 7 is a flow chart illustrating a method of dispensing powder material using a hybrid powder feed device, according to one embodiment of the present disclosure. At operation 701, the method begins by operating the hopper to dispense powder materials through a hopper outlet. In some embodiments, the hopper can dispense powder material having a size distribution between about 10 and 100 microns.

At operation 703, the auger positioned at the hopper outlet is rotated to deliver the powder material from the hopper outlet to a feeding chamber. In some embodiments, the auger can include a number of blades and can have variable pitch or variable diameter along its length. and can be rotated at a particular speed depending on the size of the powder materials.

At operation 705, a mechanical vibrator connected to a mesh screen at the outlet of the feeding chamber is vibrated. By vibrating the mechanical vibrator, a metered volume of powder material can be delivered through the outlet of the feeding chamber. In some embodiments, the vibration frequency of the mechanical vibrator can be set or adjusted depending on the powder material size, the speed of the auger, the desired powder flow speed, and/or the size of the mesh screen.

At operation 707, a gas flow is conveyed through a pneumatic system connected to the outlet of the feeding chamber. The gas flow conveys the powder material from the outlet of the feeding chamber to a plasma torch, as discussed above, and can be selected or adjusted based on the powder material size, the speed of the auger, the desired powder flow speed, and/or the size of the mesh screen. In some cases, each of the metrics discussed above can be adjusted or tailored in order to produce a desired flow of powder materials into the plasma torch.

In the foregoing specification, the invention has been described with reference to specific embodiments thereof. However, various modifications and changes can be made thereto without departing from the broader spirit and scope of the invention. The specification and drawings are, accordingly, to be regarded in an illustrative rather than a restrictive sense.

1. A system for processing fine powders, comprising:
a hopper for dispensing powder material through a hopper outlet;
a feeding chamber positioned downstream of the hopper outlet to receive the powder material and convey the powder material to a plasma torch;
a pneumatic system providing a gas flow sufficient to propel the powder material without extinguishing a plasma of the plasma torch;
an auger positioned at the hopper outlet; and
a mechanical vibrator and a mesh screen attached to a flange of the feeding chamber.

2. The system of claim 1, wherein the mechanical vibrator vibrates the mesh screen at a frequency between 1000 and 10000 Hz.

3. The system of claim 1, wherein the pneumatic system provides a gas flow between 10 and 60.

4. A method of feeding fine powders into a plasma torch, comprising:
operating a hopper to dispense powder material through a hopper outlet;
rotating an auger positioned at the hopper outlet to deliver the powder material from the hopper outlet to a feeding chamber;
vibrating a mechanical vibrator connected to a mesh screen at an outlet of the feeding chamber to deliver a metered volume of powder material through the outlet of the feeding chamber; and
conveying a gas flow through a pneumatic system connected to the outlet of the feeding chamber to convey the powder material from the outlet of the feeding chamber to a plasma torch.

5. The method of claim 4, wherein a rotation speed of the auger, a frequency of vibration of the mechanical vibrator, and a gas flow speed are each selected to produce a desired flow of powder material into the plasma torch.

6. The method of claim 4, wherein vibrating the mechanical vibrator includes vibrating the mesh screen at a frequency between 1000 to 10000 Hz.

7. The method of claim 4, wherein operating the hopper includes dispensing powder material having a size distribution between 10 to 100 microns.

8. A system for processing fine powders, comprising:
a hopper for dispensing powder material through a hopper outlet;
a feeding chamber positioned downstream of the hopper outlet to receive the powder material and convey the powder material to a plasma torch; and
a hybrid powder feed system comprising at least two of: a pneumatic system, an auger positioned at the hopper outlet, or a vibrating mesh screen device positioned at an outlet of the feeding chamber.

9. The system of claim 8, wherein the hybrid powder feed system comprises the pneumatic system and the vibrating mesh screen device positioned at the outlet of the feeding chamber.

10. The system of claim 8, wherein the hybrid powder feed system comprises the pneumatic system and the auger positioned at the hopper outlet.

11. The system of claim 8, wherein the hybrid powder feed system comprises the vibrating mesh screen device positioned at the outlet of the feeding chamber and the auger positioned at the hopper outlet.

12. The system of claim 8, wherein the hybrid powder feed system comprises the pneumatic system, the auger positioned at the hopper outlet, and the vibrating mesh screen device positioned at the outlet of the feeding chamber.

13. The system of claim 8, wherein the vibrating mesh screen device includes a mechanical vibrator and a mesh screen attached to a flange of the feeding chamber.

14. The system of claim 13, wherein the mesh screen has between 100 to 225 openings per inch.

15. The system of claim 13, wherein the mechanical vibrator vibrates the mesh screen at a frequency between 1000 and 10000 Hz.

16. The system of claim 8, wherein the hopper is designed to dispense powder material having a size distribution between 10 to 100 microns.

17. The system of claim 8, wherein the auger includes variable pitch or variable diameter along its length.

18. The system of claim 8, wherein the pneumatic system provides a gas flow between 10 to 60 SCFH argon.

19. The system of claim 18, wherein the gas flow is sufficient to propel the powder material without extinguishing a plasma of the plasma torch.

20. The system of claim 8, wherein the pneumatic system comprises a tee junction and parallel gas line for providing a secondary gas flow to the hopper.
